(19) United States
(12) Patent Application Publication
(10) Pub. No.: US 2016/0000066 A1
(43) Pub. Date: Jan. 7, 2016

(54) Furfural derivatives as a vehicle

(71) Applicants: RHODIA OPERATIONS, Aubervilliers Cedex (FR); INSTITUT NATIONAL POLYTECHNIQUE DE TOULOUSE (INPT), Tollouse Cedex 4 (FR); INSTITUT NATIONAL DE LA RECHERCHE AGRONOMIQUE (INRA), Paris Cedex 7 (FR)

(72) Inventors: Manon BERGEZ-LACOSTE, Toulouse (FR); Pascale DE CARO, Toulouse (FR); Sophie THIEBAUD-ROUX, L'union (FR); Jean-François FABRE, Toulouse (FR); Zéphirin MOULOUNGUI, Toulouse (FR); Marc BALASTRE, Paris (FR); Philippe MARION, Vernaison (FR)

(73) Assignee: INSTITUT NATIONAL DE LA RECHERCHE AGRONOMIQUE (INRA), Paris Cedex 7 (FR)

(21) Appl. No.: 14/770,516

(22) PCT Filed: Feb. 24, 2014
(86) PCT No.: PCT/IB2014/059210

§ 371 Date: Aug. 26, 2015

(30) Foreign Application Priority Data
Feb. 28, 2013 (FR) 13 51811

(51) Int. Cl. A01N 25/02; A01N 33/18; A01N 43/50; C11D 7/26; C08L 67/00; C08L 63/04; C11D 7/32; A01N 43/653; C08L 63/00

(52) U.S. Cl. CPC A01N 25/02; A01N 43/653; A01N 33/18; A01N 43/50; C08L 63/00; C08L 67/00; C08L 63/04; C11D 7/3281; C11D 7/267; C08L 2201/56

(57) ABSTRACT

The present invention concerns the use of a furfural derivative of formula (I)

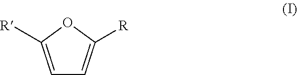

in which R represents (i) a —CH═CR′₁—COR₁ group, a group

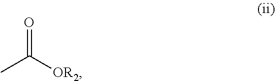

a group

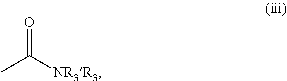

a group

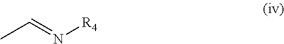

or a —CHO and R′ represents a hydrogen atom or a (C₁-C₄)alkyl group, as a chemical vehicle, as a solvent, co-solvent, coalescing agent, crystallization inhibitor, plasticising agent, degreasing agent, etchant, cleaning agent or agent for increasing biological activity, and more particularly as a solvent.

It also concerns phytosanitary formulations or resin-solubilising formulations comprising at least one such furfural derivative of formula (I).

A subject matter of the present invention is the use of furfural derivatives as vehicles for chemicals and/or solvents, in particular in plant-protection formulations and/or formulations for the solubilization of resins.

Industry uses numerous chemical compounds as solvents, for example for preparing chemicals and materials, for formulating chemical compounds or for treating surfaces.

Thus, solvents are used for the formulation of plant-protection active principles, in particular in the form of emulsifiable concentrates (EC) intended to be diluted in water by the farmer, before application over a field. Likewise, solvents are used for the formulation of plant-protection active principles, in particular in the form of microemulsions (ME) or of emulsions-in-water (EW) intended to be diluted in water by the farmer, before application over a field.

Solvents, such as, for example, acetone or dichloromethane, are also used in numerous industrial applications requiring the removal and/or the solubilization of resins. Formulations for the solubilization of resins are thus necessary for the cleaning of the equipment for application of said resins (brushes, wipes, spray nozzles, and the like) or for storage of said resins (tanks, vats, and the like), or also in order to prepare surfaces before a subsequent treatment (of the application of paint or of adhesive type, for example), and to thus improve in particular the properties of adhesion to these surfaces.

For obvious reasons, industry is continually looking for solvents which make it possible to vary or optimize the products and processes in which solvents, in particular polar solvents, are to be used. There exists in particular a need for compounds of modest cost exhibiting advantageous operational properties. Industry also has need of compounds of natural origin exhibiting a toxicological and/or ecological profile perceived as favorable, in particular a low volatility (low VOC), a bio-accumulation which is as low as possible, a low toxicity and/or a low level of danger.

There thus remains a need for novel vehicles for chemicals and/or for novel solvents, in particular in plant-protection formulations and/or in formulations for the solubilization of resins.

It is a specific aim of the present invention to provide novel vehicles for chemicals and/or novel solvents particularly suitable for plant-protection applications and/or for solubilization resins.

The inventors have found, unexpectedly, that some furfural derivatives exhibit good properties as vehicles for chemicals, in particular plant-protection products and/or resins, and meet the requirements in as regards low ecotoxicity, high solubilization capacity and low volatility.

The document H.E. Hoydonckx, “Furfural and derivatives”, Wiley-VCH Verlag GmbH & Co., 2007, reviews the physical and chemical properties of furfural and also of some of its derivatives, its sources and also the routes for the production thereof. Furfural is described therein as such as suitable as solvent. On the other hand, this document is silent with regard to the capabilities as vehicle for chemicals and/or as solvent of some furfural derivatives which are described therein. In particular, some furoic acid esters are essentially provided therein as synthetic intermediates for active principles.

A subject matter of the present invention is the use of a furfural derivative of formula (I):

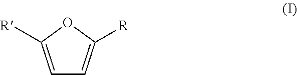

in which:

R represents:
(i) a —CH═CR′₁—COR₁ group, in which R₁ represents a hydrogen atom, an OH group, a (C₁-C₁₀)alkoxy group, a (C₁-C₁₀)alkyl group or a (C₁-C₁₀)alkenyl group and in which R′₁ represents a hydrogen atom, a (C₁-C₈)alkyl group or a (C₁-C₈)alkenyl group,
(ii) a

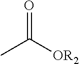

group, in which R₂ represents:
a (C₁-C₁₀)alkyl group or a (C₁-C₁₀)alkenyl group, it being possible for said groups to be interrupted by an oxygen atom and it being possible for said groups to be optionally substituted by one or two group(s) chosen from a hydroxyl group, a (C₁-C₄)alkoxy group and a phenyl group,
a (C₃-C₆)cycloalkyl group, and
a phenyl or furfuryl group,
(iii) a

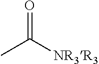

group, in which R₃ represents a (C₁-C₁₀)alkyl group, it being possible for said group to be optionally substituted by one or two hydroxyl group(s), or represents a (C₃-C₆)cycloalkyl group and R₃′ represents a hydrogen atom or a (C₁-C₆)alkyl group which can also be substituted by one or two hydroxyl group(s),
(iv) a

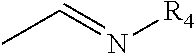

group, in which R₄ represents a (C₁-C₁₀)alkyl group or represents a (C₃-C₆)cycloalkyl group, or
(v) a —CHO group, and
   R′ represents a hydrogen atom or a (C₁-C₄)alkyl group, in particular a methyl group,
      as vehicle for chemical, as solvent, cosolvent, coalescence agent, crystallization inhibitor, plasticizing agent, degreasing agent, stripping agent, cleaning agent or agent for enhancing biological activity, more particularly as solvent.

In the context of the present invention, compound of formula (I) can be a mixture of compounds of formula (I).

Furthermore, the compounds obtained by hydrogenation of the furfural derivatives of formula (I), and also their use as vehicle for chemical, as solvent, cosolvent, coalescence agent, crystallization inhibitor, plasticizing agent, degreasing agent, stripping agent, cleaning agent or agent for enhancing biological activity, more particularly as solvent, are also covered by the invention. These compounds can be obtained by subjecting the furfural derivatives of formula (I) to an additional hydrogenation reaction, according to conventional techniques known to a person skilled in the art.

“Vehicle for chemical” is understood to mean, in the context of the present invention, a chemical compound capable of containing, dissolving, solubilizing and/or transporting a significant amount of a given chemical, for example for the purpose of obtaining a homogeneous and unsaturated medium or else for the purpose of removal.

When the vehicle for active product is in the liquid state, the term “a solvent” is generally used.

It should be noted that some compounds according to the invention can occur in the solid state at ambient temperature. However, these particular compounds remain effective for the applications envisaged according to the invention, in particular the applications as solvent or cosolvent.

According to the field of application targeted, it may be possible to employ these compounds in the liquid form by applying a temperature greater than their melting point. If the field of application targeted requires being positioned at a temperature lower than their melting point, for example at ambient temperature, it is then possible to combine these compounds with other additives or solvents capable of lowering their melting point. Mention may in particular be made, as example of such additives, of the additives which lower the pour point (pour point depressant). The development of such combinations forms part of the general knowledge of a person skilled in the art.

As will emerge in more detail below, the chemical compound(s) conveyed by the compounds of formula (I) according to the invention may be very varied in nature. A plant-protection product or also a resin, in particular an epoxy, polyurethane or polyester resin, may in particular be concerned.

In the present patent application, the term “solvent” is understood in a broad sense, covering in particular the functions of cosolvent, crystallization inhibitor, coalescence agent and stripping agent. The term solvent may in particular denote a product which is liquid at the temperature of use, preferably with a melting point of less than or equal to 40° C., preferably of less than or equal to 20° C., which can contribute to rendering a solid material liquid, to rendering a viscous liquid more fluid or to preventing or slowing down the solidification or the crystallization of material in a liquid medium.

Cosolvent is understood to mean that other solvents may be combined with it.

As also appears in more detail in the description which will follow and in particular in the examples, it is the solubility tests which reflect the ability of a compound in accordance with the invention to be used as solvent.

The use as solvent or cosolvent comprises in particular the use for dissolving a compound in a formulation, in a reaction medium, the use for completely or partially solubilizing a product to be removed (degreasing, stripping) and/or for facilitating the detachment of films of materials. The product to be removed may in particular be an oil, greases, waxes, petroleum oil, resins, paint or graffiti and more particularly resins, such as epoxy, polyurethane or polyester resins. A furfural derivative in accordance with the invention may in particular be used as pretreatment agent which facilitates the deletion of graffiti after their appearance.

Agent for enhancing biological activity denotes a compound which, in combination with a molecule exhibiting a biological activity, will make it possible to enhance the biological activity of said molecule (for example, synergy).

Another subject matter of the invention is thus the use of a compound of formula (I) in accordance with the invention as stripping agent, crystallization inhibitor, cleaning agent, degreasing agent, plasticizing agent, coalescence agent or agent for enhancing biological activity.

Another subject matter of the invention is the use of a compound of formula (I) in accordance with the invention as vehicle or solvent for a plant-protection product or as vehicle or solvent for a resin, in particular for an epoxy resin, for a polyurethane resin or for a polyester resin.

Another subject matter of the invention is a plant-protection formulation comprising at least one compound of formula (I) in accordance with the invention in combination with a plant-protection active product.

Finally, a subject matter of the invention is a formulation for the solubilization of resin comprising at least one compound of formula (I) in accordance with the invention.

The subfamily in which R is a (i) group corresponds to furfurylideneketone derivatives.

The subfamily in which R is a (ii) group corresponds to alkyl furoate derivatives.

The subfamily in which R is a (iii) group corresponds to amide derivatives of furfural.

The subfamily in which R is a (iv) group corresponds to imine derivatives of furfural.

The subfamily in which R is a (v) group corresponds to furfural substituted on its ring.

According to the present invention, the “(C₁-Cₚ)alkyl” groups represent saturated straight-chain or branched-chain hydrocarbon groups comprising from 1 to p carbon atoms, preferably from 1 to 10 carbon atoms, for example from 1 to 8 carbon atoms and more preferably still from 1 to 6 carbon atoms (they may typically be represented by the formula CₙH₂₊₁, n being an integer representing the number of carbon atoms).

Mention may in particular be made, when they are linear, of the methyl, ethyl, propyl, butyl, pentyl, hexyl, heptyl, octyl, nonyl and decyl groups. Mention may in particular be made, when they are branched or substituted by one or more alkyl groups, of the isopropyl, isobutyl, tert-butyl, sec-butyl, isopentyl, 2-methylbutyl, sec-pentyl, isohexyl, sec-hexyl, 2-ethylbutyl, 3-methylpentyl, isoheptyl, sec-heptyl, 3-methylhexyl, 4-methylhexyl, 1-ethylpentyl, 2-ethylpentyl, 3-ethylpentyl, isooctyl and 3-methylheptyl groups.

“(C₁-Cₚ)alkenyl” group is understood to mean a hydrocarbon group comprising from 1 to 2 unsaturations and comprising from 1 to p carbon atoms, preferably from 1 to 10 carbon atoms, for example from 1 to 8 carbon atoms and more preferably still from 1 to 6 carbon atoms. Mention may be made, as example, of the —CH₂—CH═CH₂ or —C(CH₃)═CH₂ group.

“(C₃-C₆)cycloalkyl” group is more particularly envisaged as being a monocyclic carbocyclic group having from 3 to 6 carbon atoms and preferably 5 or 6 carbon atoms. Mention may preferably be made of the cyclopentyl or cyclohexyl group.

“Alkoxy” group is understood to mean an —O-alkyl group, the alkyl group being as defined above.

According to a specific embodiment, the furfural derivative in accordance with the invention is a compound of formula (I) in which:

R represents:
(i) a —CH═CH—COR₁ group, in which R₁ represents a (C₁-C₆)alkoxy group or a (C₁-C₆)alkyl group,
(ii) a

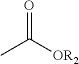

group, in which R₂ represents a (C₁-C₆)alkyl group, which can be substituted by a phenyl group or a hydroxyl group,
(iii) a

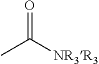

group, in which R₃ represents a (C₁-C₈)alkyl group and R₃′ represents a hydrogen atom,
(iv) a

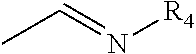

group, in which R₄ represents a (C₁-C₈)alkyl group, or
(v) a —CHO group, and
   R′ represents a hydrogen atom or a methyl group.

Mention may in particular be made, among the compounds of formula (I), of the following derivatives, collated in Table I.

TABLE I

| Compound | | |
|---|---|---|
| number | Subfamily | Formula |
| (1) | (i) | 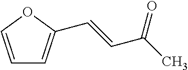 |
| (2) | (i) | 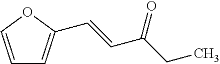 |
| (3) | (i) | 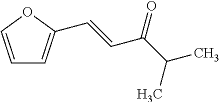 |
| (4) | (i) | 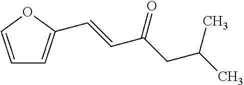 |
| (5) | (i) | 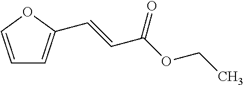 |
| (6) | (ii) | 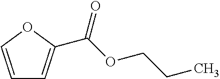 |
| (7) | (ii) | 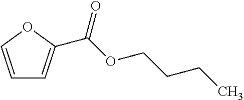 |
| (8) | (ii) | 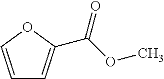 |
| (9) | (ii) | 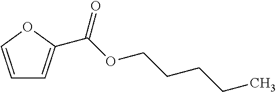 |
| (10) | (ii) | 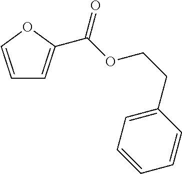 [SMILES: O=C(OCCc1ccccc1)c1ccco1] |
| (11) | (ii) | 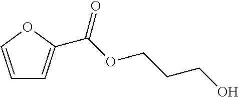 [SMILES: O=C(OCCCO)c1ccco1] |
| (12) | (ii) | 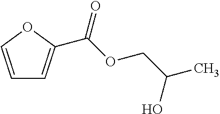 |
| (13) | (iii) | 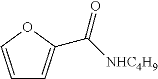 |
| (14) | (iii) | 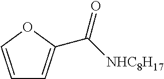 |
| (15) | (iv) | 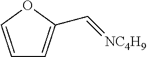 |
| (16) | (iv) | 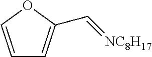 |
| (17) | (v) | 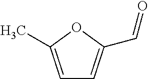 |

According to yet another embodiment, the furfural derivative in accordance with the invention is a compound of formula (I) in which:

R represents:
(i) a —CH═CH—COR₁ group, in which R₁ represents a (C₁-C₆)alkyl group or a (C₁-C₄)alkoxy group,
(ii) a

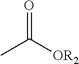

group, in which R₂ represents a (C₁-C₆)alkyl group which can be substituted by a phenyl group or a hydroxyl group, or
(v) a —CHO group, and
   R′ represents a hydrogen atom or a methyl group.

According to yet another embodiment, the furfural derivative in accordance with the invention is a compound of formula (I) in which:

R represents:
(i) a —CH═CH—COR₁ group, in which R₁ represents a (C₁-C₆)alkyl group, or a (C₁-C₄)alcoxy group, or
(ii) a

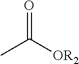

group, in which R₂ represents a (C₁-C₆)alkyl group which can be substituted by a phenyl group or a hydroxyl group, and
R′ represents a hydrogen atom.

Some compounds of formula (I) are known and are commercially available. For example, the compound (17) is available commercially from Sigma Aldrich.

In fact, the majority of the derivatives considered in the context of the present invention can be obtained from said furfural according to processes described below. As such, it should be noted that furfural exhibits the advantage of being accessible via biomass, in particular corn and bagasse or fibrous waste from sugar cane passed through the mill for extraction of the juice.

In any case, the compounds of formula (I)(i), namely the furfurylideneketone derivatives, for which R₁ is a hydrogen atom, a (C₁-C₁₀)alkyl group or a (C₁-C₁₀)alkenyl group, can be prepared according to the following scheme 1.

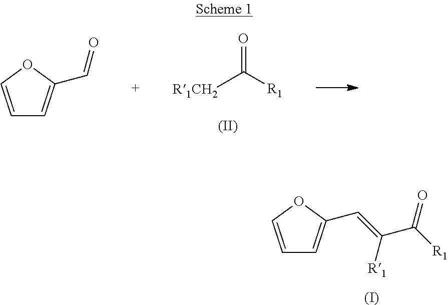

According to this scheme 1, it is possible to react furfural with a ketone of formula (II), in which R₁ is a hydrogen atom or a (C₁-C₁₀)alkyl group or a (C₁-C₁₀)alkenyl group and R′₁ is a hydrogen atom or a (C₁-C₈)alkyl group, in the presence of sodium hydroxide. The compound of formula (II) can in particular be acetone, butanone or also citronellal. The reaction mixture can be left at ambient temperature or heated, for example at a temperature of between 30° C. and the boiling temperature of the ketone used, typically at 60° C., for example for a period of between 30 min and four hours, typically two hours.

The mixture may subsequently be brought back to a pH of between 6 and 2, typically to pH=4, for example using a hydrochloric acid solution.

The reaction mixture may subsequently be separated by settling, the organic phase washed, for example with distilled water, and the aqueous phase extracted, for example with ethyl acetate.

The compounds of formula (I)(i), namely the furfurylideneketone derivatives, for which R₁ is a (C₁-C₁₀)alcoxy group, can be prepared according to the following scheme 2.

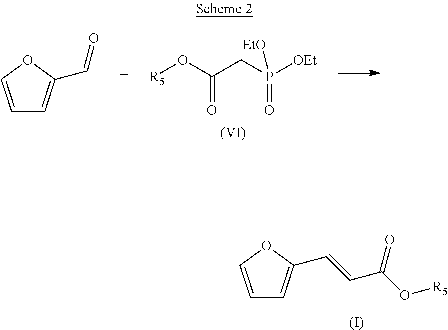

According to this scheme 2, it is possible to react furfural with a phosphonoester of formula (VI), in which R₅ is a (C₁-C₁₀)alkyl group, in the presence of a base which can be barium hydroxide and in a solvent which can be 1,4-dioxane to which water has been added. The reaction mixture can be left at ambient temperature or heated, for example at a temperature of between 40° C. and 80° C., typically 70° C., for a period of between 30 min and three hours, typically two hours.

The reaction mixture may subsequently be filtered and the cake washed, for example with 1,4-dioxane.

When R₁ is an OH group, the compound is obtained by hydrolysis of the compound, the synthesis of which is described in scheme 2 above.

The compounds of formula (I)(ii) may be prepared according to the following scheme 3.

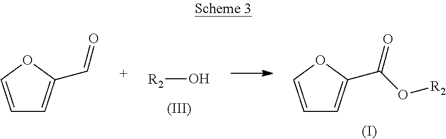

According to this scheme 3, it is possible to react furfural with an alcohol of formula (III), in which R₂ is as defined above, in the presence of an oxidizing agent which can be chosen from t-butyl hydroperoxide (TBHP) or aqueous hydrogen peroxide solution. It is possible to let reflux take place for 12 to 72 hours, for example for 20 hours. The mixture may subsequently be brought back to a pH of between 8 and 6, typically to pH=7, using a saturated sodium sulfite solution.

The compounds of formula (I)(iii) may be prepared according to the following scheme 4.

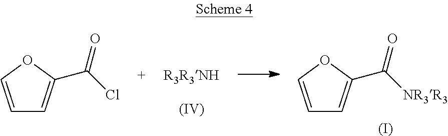

According to this scheme 4, it is possible to react an amine of formula (IV), in which R₃ and R₃′ are as defined above, with 2-furoyl chloride in a solvent, such as dichloromethane or toluene, or without addition of solvent for a period which can be between 10 minutes and 2 hours, typically 30 minutes.

The compounds of formula (I)(iv) can be prepared according to the following scheme 5.

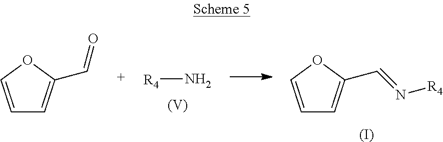

According to this scheme 5, it is possible to react an amine of formula (V), in which R₄ is as defined above, with furfural in the presence of a dehydrating agent, for example magnesium sulfate, in a solvent such as toluene, for a period which can be between 1 and 2 hours, typically 1 hour.

The compound according to the invention of formula (I) may in particular be used as solvent, cosolvent, stripping agent, crystallization inhibitor or coalescence agent.

The compound in accordance with the invention of formula (I) may in particular be used, for the functions indicated above or for others, in a plant-protection formulation, in a cleaning formulation, in a stripping formulation, in a degreasing formulation, in a lubricating formulation, in a formulation for cleaning or degreasing textiles, in a coating formulation, for example in a paint formulation, in a pigment or ink formulation, in a plastic formulation, in a formulation for the solubilization of resins, in particular PVDF (polyvinylidene fluoride powder) resins, epoxy, polyurethane or polyester resins, in a formulation for cleaning “light-sensitive resins” or also in a formulation for cleaning screens, in particular liquid crystal (LCD) screens.

The compound may, for example, be used as coalescence agent in a water-based paint formulation. It may be used as solvent in a non-water-based paint formulation.

The compound may in particular be used as degreasing agent on metal surfaces, for example surfaces of implements, manufactured items, metal sheets or molds, in particular made of steel or of aluminum or of alloys of these metals.

The compound may in particular be used as cleaning solvent on hard surfaces or textile surfaces. It may be used for the cleaning of industrial sites, for example sites with extraction of oil or gas, for example, offshore or non-offshore oil platforms.

The compound may in particular be used as solvent for stripping paint or resins on surfaces of implements, for example casting molds, or on surfaces of industrial sites (floors, partitions, and the like).

The compound may in particular be used as solvent for resins, for example in the industry for the coating of cables or in the electronics industry, in particular as solvent for PVDF.

The compound may in particular be used as cleaning and/or stripping solvent in the electronics industry. It may in particular be used in lithium batteries. It may in particular be used on photoresist resins, polymers, waxes, greases or oils.

The compound may in particular be used for the cleaning of inks, for example during the production of inks or during the use of printing ink.

The compound may in particular be of use as solvent for cleaning or stripping printing devices.

The compound may in particular be used for the bleaching of paper.

The compound may in particular be used for the cleaning of sieves or other implements employed in processes for the manufacture and/or recycling of paper.

The compound may in particular be used for the cleaning of asphalts or tar sands, for example on coated substrates, on the implements used for applying these materials, on contaminated clothing or on contaminated vehicles.

The compound may in particular be used for the cleaning of aerial vehicles, such as airplanes, helicopters or space shuttles.

The compound may be in particular used as plasticizing agent in thermoplastic polymer formulations.

The cleaning and/or degreasing formulations may in particular be formulations for household care, worked in homes or in public areas (hotels, offices, factories, and the like). They may be the formulations for the cleaning of hard surfaces, such as floors, surfaces of kitchen and bathroom furniture and fittings, or dishes. These formulations may also be used in the industrial sphere for degreasing manufactured products and/or cleaning them.

According to a specific embodiment of the invention, the compound of formula (I) may thus be used as solvent or cosolvent in a formulation for the solubilization of resins, in particular epoxy resins, polyester resins and/or polyurethane resins.

According to an embodiment, the compound in accordance with the invention may in particular be used as solvent or cosolvent in a formulation for the solubilization of epoxy resins.

Epoxy resins are well known to a person skilled in the art.

Two main categories of epoxy resins exist: epoxy resins of glycidyl type and epoxy resins of non-glycidyl type. The epoxy resins of glycidyl type are themselves categorized into glycidyl ether, glycidyl ester and glycidyl amine. The non-glycidyl epoxy resins are of aliphatic or cycloaliphatic type.

The glycidyl epoxy resins are prepared by a condensation reaction of the appropriate dihydroxy compound with a diacid or a diamine and with epichlorhydrin. Non-glycidyl epoxy resins are formed by peroxydation of the olefinic double bonds of a polymer.

Among glycidyl epoxy ethers, bisphenol A diglycidyl ether (BADGE), represented below, is the most commonly used.

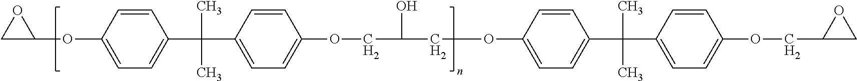

Resins based on BADGE have excellent electrical properties, a low shrinkage, good adhesion to numerous metals, good resistance to humidity, good thermal resistance and good resistance to mechanical impacts.

The properties of BADGE resins depend on the value of n, which is the degree of polymerization, which itself depends on the stoichiometry of the synthesis reaction. As a general rule, n varies from 0 to 25.

Mention may also be made, among glycidyl epoxy ethers, of triglycidyl p-aminophenol ether (TGPA).

Novolac epoxy resins (the formula of which is represented below) are glycidyl ethers of novolac phenolic resins. They are obtained by reaction of phenol with formaldehyde in the presence of an acid catalyst in order to produce a novolac phenolic resin, followed by a reaction with epichlorhydrin in the presence of sodium hydroxide as catalyst.

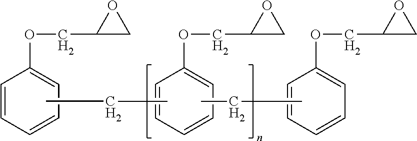

Novolac epoxy resins generally comprise several epoxide groups. The multiple epoxide groups make it possible to produce resins having a high crosslinking density. Novolac epoxy resins are widely used to formulate molded compounds for microelectronics due to their greater resistance at a high temperature, with excellent suitability for molding and their superior mechanical, electrical, heat-resistance and moisture-resistance properties.

The compounds in accordance with the invention can be used to solubilize a great variety of epoxy resins, for example Novolac epoxy resins, bisphenol A diglycidyl ether (BADGE), bisphenol F diglycidyl ether (BFDGE), tetraglycidyl methylenedianiline, pentaerythritol tetraglycidyl ether, tetrabromobisphenol A diglycidyl ether, hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, terephthalic acid diglycidyl ester, poly(glycidyl acrylate), poly(glycidyl methacrylate) and their mixtures.

According to one embodiment, the epoxy resins are chosen from BADGE, BFDGE, TGPA and Novolac resins.

Mention may in particular be made, by way of illustration, of the BADGE epoxy resins DER 331, DER 333, DER 334, DER 337 and DER 338, the BFDGE resin DER 354 and the Novolac resins DEN 425, DEN 427, DEN 428, DEN 430, DEN 431 and DEN 432 sold by DOW CHEMICAL.

By way of illustration, TGPA is available from Sigma Aldrich.

According to another embodiment, the compound in accordance with the invention may in particular be used as solvent or cosolvent in a formulation for the solubilization of polyester resins.

Polyester resins are well known to a person skilled in the art.

They are obtained by a condensation polymerization reaction starting from diols, such as propylene glycol or bisphenol A and unsaturated acids or their anhydrides, such as fumaric acid or maleic anhydride, together with saturated acids or their anhydrides, for example isophthalic acid, orthophthalic acid or phthalic anhydride. The crosslinking monomer may be styrene, for example.

Numerous thermosetting polyester resins are commercially available, for example under the Alpolit, Ampal, Atlac, Beetle, Cellobond, Crystic, Gabraster, Grilesta, Hetron, Legupren, Leguval, Norsodyne, Palatal, Sirester, Stypol, Synolite, Synres, Ukapron, Vestopal or Ugikapon trade name.

The compounds in accordance with the invention can be used to solubilize a great variety of polyester resins, in particular those listed above, and especially those available under the Palatal trade name, which comprise, as monomers, isophthalic acid, or orthophthalic acid, maleic anhydride and glycols dissolved in styrene.

Mention may in particular be made, by way of illustration, of the Palatal polyester resins A400-01, A400-03, A400-04, A400-06, A400-07 and A400-08 sold by DSM.

According to another embodiment, the compound in accordance with the invention may in particular be used as solvent or cosolvent in a formulation for the solubilization of polyurethane resins.

Polyurethane resins are well known to a person skilled in the art.

Mention may in particular be made, by way of illustration, of the Suprasec 2982 diisocyanate resin sold by Huntsman.

According to another specific embodiment of the invention, the compound of formula (I) may thus be used in plant-protection formulations comprising a solid active product.

The plant-protection formulation is generally a concentrated plant-protection formulation comprising an active product.

Agriculture makes use of numerous active materials (or active products), such as fertilizers or pesticides, for example insecticides, herbicides or fungicides. The reference is to plant-protection active products (or active materials). Plant-protection active products are generally products in the pure or highly concentrated form. They have to be used on farms at low concentrations or used to treat agricultural products after harvesting. To this end, they are generally formulated with other ingredients in order to make possible easy dilution by the farmer. The reference is to plant-protection formulations. The dilution carried out by the farmer is generally carried out by mixing the plant-protection formulation with water.

Thus, plant-protection formulations have to make possible easy dilution by the farmer in order to obtain a product in which the plant-protection product is correctly dispersed, for example in the solution, emulsion, suspension or suspoemulsion form. Plant-protection formulations thus make possible the transportation of a plant-protection product in the relatively concentrated form, easy packaging and/or easy handling for the final user. Different types of plant-protection formulations may be used according to the different plant-protection products. Mention is made, for example, of emulsifiable concentrates (“EC”), concentrated emulsions (Emulsion, oil in water, “EW”), microemulsions (“ME”), wettable powders (“WP”) or water-dispersible granules (“WDG”). The formulations which it is possible to use depend on the physical form of the plant-protection product (for example solid or liquid) and on its physicochemical properties in the presence of other compounds, such as water or solvents.

After dilution by the farmer, for example by mixing with water, the plant-protection product may occur in different physical forms: solution, dispersion of solid particles, dispersion of droplets of the product, droplets of solvent in which the product is dissolved, and the like. Plant-protection formulations generally comprise compounds which make it possible to obtain these physical forms. They may, for example, be surfactants, solvents, inorganic supports and/or dispersants. Very often, these compounds do not have an active nature but a nature of ingredient in helping in the formulation. Plant-protection formulations may in particular be in the liquid form or in the solid form.

In order to prepare plant-protection formulations of solid plant-protection active products, it is known to dissolve the product in a solvent. The plant-protection formulation thus comprises a solution of the product in the solvent. The formulation may be in the solid form, for example in the form of a wettable powder (WP) where the solution impregnates an inorganic support, for example kaolin and/or silica. The formulation may alternatively be in the liquid form, for example in the form of an emulsifiable concentrate (EC) exhibiting a single clear liquid phase comprising the solvent and the product in solution, which may form an emulsion by addition of water, without stirring or with gentle stirring. It may also be in the form of a concentrated emulsion (EW), the phase of which dispersed in the water comprises the solvent and the product in solution in the solvent. It may also be in the form of a clear microemulsion (ME), the phase of which dispersed in the water comprises the solvent and the product in solution in the solvent, of a soluble concentrate (SL) exhibiting a single liquid phase comprising the solvent and the product in solution, which may form a solution by addition of water, or of a suspoemulsion (SE) comprising at least two phases in dispersion, a solid and a liquid.

For some plant-protection active principles, it is difficult to produce concentrated formulations which are easy to dilute for the farmer, which are stable and which are without substantial disadvantages (known or perceived) with regard to safety, toxicity and/or ecotoxicity. For some active principles, it is difficult to formulate at relatively high concentrations with a satisfactory stability. In particular, it is necessary to avoid the appearance of crystals, in particular at low temperature and/or during the dilution and/or during the storage of the diluted composition. The crystals may have negative effects, in particular may block the filters of the devices used to spread the diluted composition, may block the spray devices, may reduce the amount of formulation distributed over the field, may create needless problems of waste procedures in order to remove the crystals, and/or may cause poor distribution of the active product over the agricultural field.

For example, tebuconazole is a particularly effective and widely used fungicide, in particular for the cultivation of soya, which often shows this type of behavior.

The formulations comprising at least one solvent of the present invention exhibit in particular:
solubilization of large amounts of active principles,
absence of crystallization, even at demanding conditions, and/or
good biological activity, which may be due to good solvation.

The plant-protection formulation may in addition be a concentrated plant-protection formulation comprising:
a) a plant-protection active product,
b) the compound of formula (I) according to the present invention,
c) optionally at least one cosolvent or another solvent,
d) optionally at least one surface-active agent, and
e) optionally water.

Plant-protection active products, in particular water-insoluble and solid products, are known to a person skilled in the art. The plant-protection active product may be in particular a herbicide, an insecticide, an acaricide, a fungicide or a rodenticide, for example, a raticide.

Mention may be made, as examples of insecticides and acaricides suitable for the invention, of those which belong to the families:
of the organohalogen or chlorinated compounds, such as, for example, DDT (dichlorodiphenyltrichloroethane), lindane (gamma isomer of hexachlorocyclohexane), chlordane (octachlorohexahydromethanoindene), or toxaphene;
of the carbinols, such as, for example, dicofol (dichlorophenyltrichloroethanol);
of the organophosphorus compounds, such as, for example, bromophos (4-bromo-2,5-dichlorophenoxy)dimethoxythioxophosphorane), diazinon (O,O-diethyl O-(2-isopropyl-6-methylpyrimidin-4-yl) phosphorothioate), fenitrothion (O,O-dimethyl-O-nitro-4-m-tolyl phosphorothioate), malathion (S-1,2-bis(ethoxycarbonyl)ethyl O,O-dimethyl phosphorodithioate), parathion (O,O-diethyl O-4-nitrophenyl phosphorothioate), trichlorfon (dimethyl (2,2,2-trichloro-1-hydroxyethyl)phosphonate) or dimethoate (O,O-dimethyl S-methylcarbamoylmethyl phosphorodithioate);
of the sulfones and sulfonates, such as, for example, tetradifon (tetrachlorodiphenyl sulfone);
of the carbamates, such as, for example, carbaryl (naphthyl N-methylcarbamate) or methomyl (methyllthioethylideneamine N-methylcarbamate);
of the benzoylureas, such as, for example, diflubenzuron ((difluorobenzoyl)(chlorophenyl)urea);
of the synthetic pyrethroids;
of the acaricides, such as, for example, cyhexatin (tricyclohexylhydroxystannane).

The fungicides capable of being employed in the invention may, for example, be chosen from:
carbamates, such as, for example, benomyl (methyl butylcarbamoylbenzimidazolylcarbamate), carbendazim (methyl benzimidazolylcarbamate), ziram (zinc dimethyldithiocarbamate), zineb (zinc ethylenebis(dithiocarbamate)), maneb (manganese ethylenebis(dithiocarbamate)), mancozeb (manganese zinc ethylenebis(dithiocarbamate)) or thiram (bis(dimethylthiocarbamoyl) disulfide);
benzene derivatives, such as, for example, PCNB (pentachloronitrobenzene);
phenol derivatives, such as, for example, dinocap ((methylheptyl)dinitrophenyl crotonate);
quinones, such as, for example, dithianon (dioxodihydronaphthodithiinedicarbonitrile);
dicarboximides, such as, for example, captan (trichloromethylthiotetrahydroisoindolinedione), folpet (trichloromethylthioisoindolinedione) or iprodione (isopropylcarbamoyldichlorophenylhydantoin);
amines and amides, such as, for example, benodanil (iodobenzanilide) or metalaxyl (methyl dimethylphenylmethoxyacetylalaninate);
diazines, such as, for example, pyrazophos (ethyl ethoxycarbonylmethylpyrazolopyrimidinyl thiophosphate) or fenarimol ((chlorophenyl)(chlorophenyl)pyrimidinemethanol);
sulfamides and sulfur derivatives, such as, for example, dichlofluanid ((dichlorofluoromethylthiol)(dimethyl)phenylsulfamide);
guanidines, such as, for example, dodine (dodecylguanidine acetate);
heterocycles, such as, for example, etridiazol (ethoxy(trichloromethyl)thiadiazol) or triadimefon (chlorophenoxydimethyltriazolylbutanone);
metal monoethyl phosphites, such as, for example, fosetyl-Al (aluminum tris(O-ethyl phosphonate));
organotin compounds, such as, for example, fentin acetate (triphenyltin acetate).

Recourse may be had, as chemical substances exhibiting herbicidal properties, to those which are found under the following chemical formulae:
phenolic compounds, such as, for example, dinoseb (dinitrobutylphenol);
carbamates, such as, for example, phenmedipham (methyl tolylcarbamoyloxyphenylcarbamate);
substituted ureas, such as, for example, neburon (butyl(dichlorophenyl)methylurea), diuron ((dichlorophenyl)dimethylurea) or linuron ((dichlorophenyl)(methoxy)methylurea);
diazines, such as, for example, bromacil (bromobutylmethyluracil) or chloridazon (phenylaminochloropyridazinone);
triazines, such as, for example, simazine (chlorobis(ethylamino)-striazine), atrazine (chloro(ethylamino)isopropylamino-s-triazine), terbuthylazine (chloro(ethylamino)(butylamino-s-triazine), terbumeton (tert-butylamino(ethylamino)methoxy-s-triazine), prometryn (methylthiobis(isopropylamino)-s-triazine), ametryn (methylthio(ethylamino)isopropylamino-s-triazine), metribuzin (methylthiol(butyl)aminotriazinone) or cyanazine (chloro(ethylamino)-s-triazinylamino(methyl)propionitrile);
amides, such as, for example, napropamide (naphthoxydiethylpropionamide) or propachlor (isopropyl chloroacetanilide);
quaternary ammoniums;
benzonitriles;
toluidines, such as, for example, ethalfluralin (dinitro(ethyl)(methylpropenyl)trifluoromethylaniline) or oryzalin (dinitrodipropylsulfanilamide);
triazoles;
various derivatives, such as, for example, benazolin (chlorooxobenzothiazolineacetic acid), dimefuron ((chloro(oxo)(tert-butyl)oxadiazolinylphenyl)dimethylurea), bromofenoxim (dibromohydroxybenzaldehyde dinitrophenyloxime) or pyridate (octyl chloro(phenyl)pyridazinyl carbonothioate).

Mention may be made, as other examples of biocides which may be used according to the invention, of nematicides, molluscicides, and the like. It is possible to employ one or more active materials belonging to the same class of biocides or to a different class.

Mention may be made, as nonlimiting examples of suitable active materials, inter alia, of ametryn, diuron, linuron, chlortoluron, isoproturon, nicosulfuron, metamitron, diazinon, aclonifen, atrazine, chlorothalonil, bromoxynil, bromoxynil heptanoate, bromoxynil octanoate, mancozeb, maneb, zineb, phenmedipham, propanil, the phenoxyphenoxy series, the heteroaryloxyphenoxy series, CMPP, MCPA, 2,4-D, simazine, the active products of the imidazolinone series, the family of the organophosphorus compounds, with in particular azinphos-ethyl, azinphos-methyl, alachlor, chlorpyrifos, diclofop-methyl, fenoxaprop-P-ethyl, methoxychlor, cypermethrin, fenoxycarb, cymoxanil, chlorothalonil, the neonicotinoid insecticides, the family of the triazole fungicides, such as azaconazole, bromuconazole, cyproconazole, difenoconazole, diniconazole, epoxiconazole, fenbuconazole, flusilazole, myclobutanil, tebuconazole, triadimefon and triadimenol, strobilurins, such as pyraclostrobin, picoxystrobin, azoxystrobin, famoxadone, kresoxim-methyl and trifloxystrobin, or sulfonylureas, such as bensulfuron-methyl, chlorimuron-ethyl, chlorsulfuron, metsulfuron-methyl, nicosulfuron, sulfometuron-methyl, triasulfuron, tribenuron-methyl, trifluralin and imidacloprid.

The water-insoluble products are chosen from this list.

The plant-protection active product may in particular be chosen from azoles, preferably triazoles, preferably tebuconazole. Tebuconazole is the normal name of a compound known to a person skilled in the art, the formula of which is as follows:

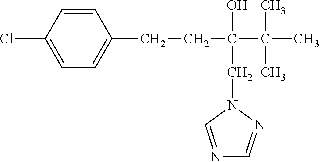 [SMILES: CC(C)(C)C(O)(CCc1ccc(Cl)cc1)Cn1cncn1]

Tebuconazole is a solid plant-protection product.

Mention may in particular be made, as triazoles other than tebuconazole, of the following compounds: azaconazole, bitertanol, bromuconazole, cyproconazole, diclobutrazol, difenoconazole, diniconazole, diniconazole-M, epoxiconazole, etaconazole, fenbuconazole, fluotrimazole, fluquinconazole, flusilazole, flutriafol, furconazole, furconazole-cis, hexaconazole, imibenconazole, ipconazole, metconazole, myclobutanil, penconazole, prochloraz, propiconazole, prothioconazole, quinconazole, strobulurin and analogs, simeconazole, tetraconazole, triadimefon, triadimenol, triazbutil, triflumizole, triticonazole, uniconazole and uniconazole-P.

The plant-protection active product may in particular be chosen from dinitroanilines, such as pendimethalin or trifluralin.

Use may in particular be made of the following plant-protection active products:

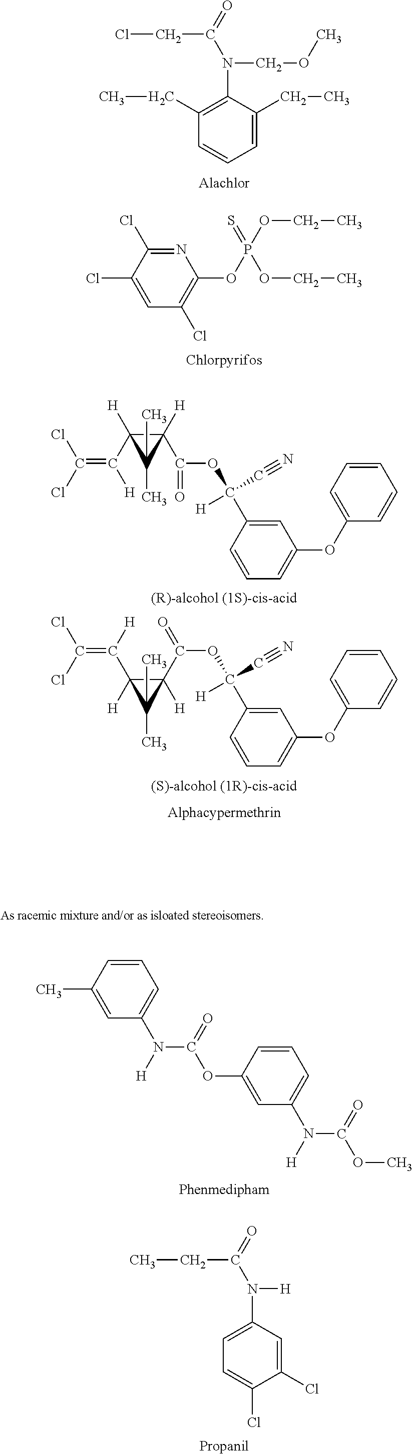

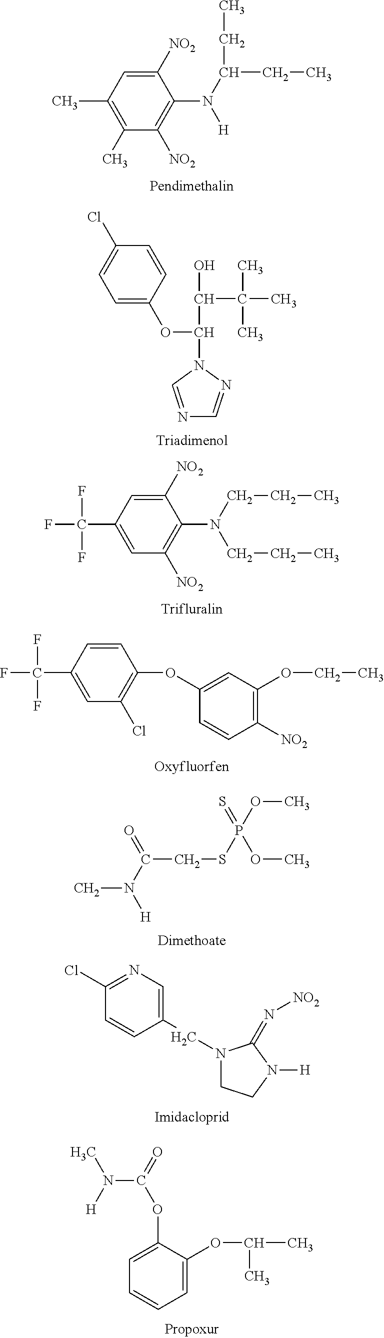

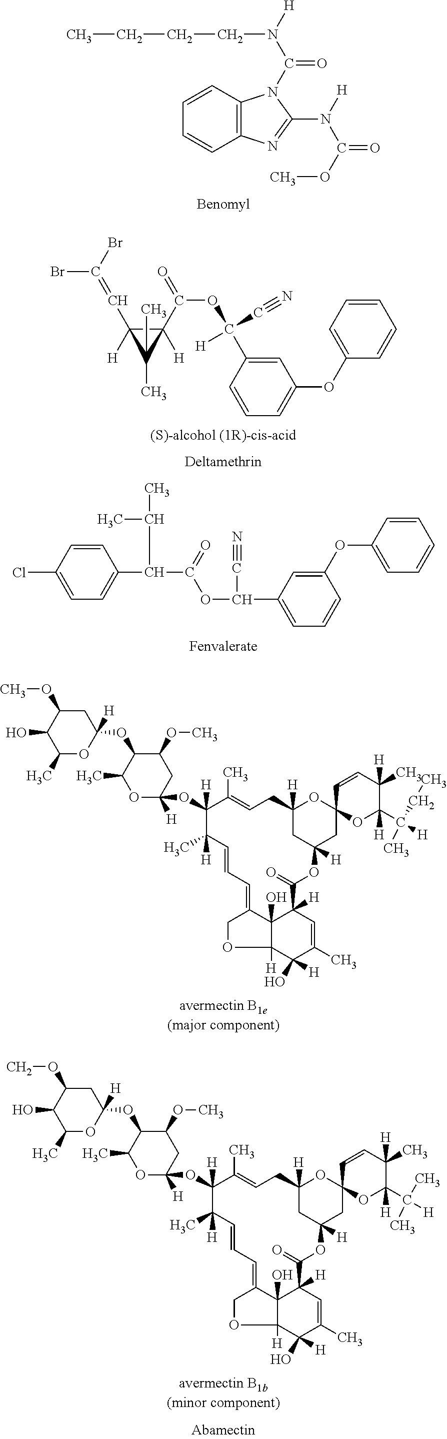

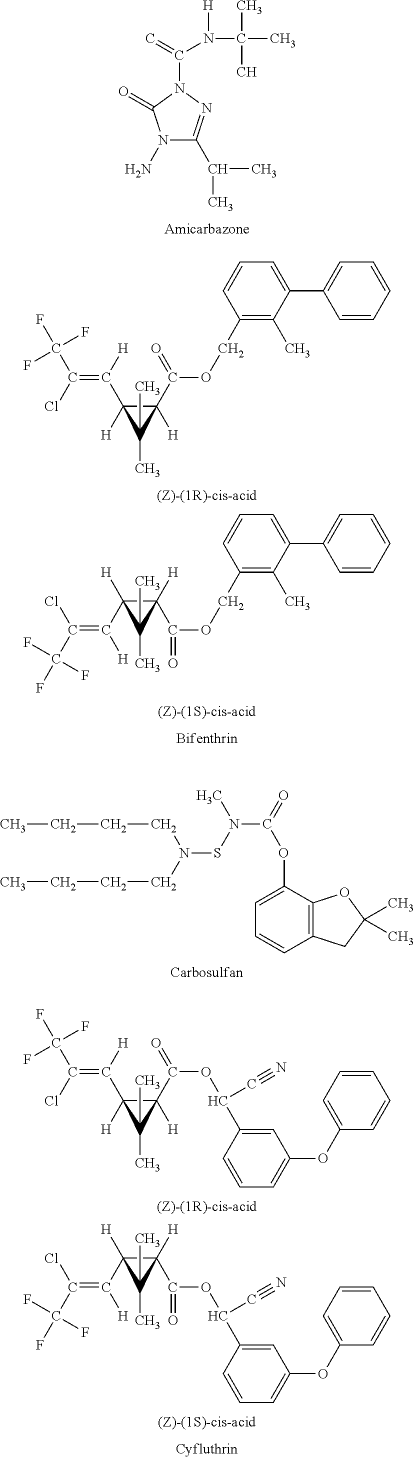 [SMILES: C=C(NC(C)(C)C)n1nc(C(C)C)n(N)c1=O ; Cc1c(COC(=O)[C@@H]2[C@H](/C=C(\Cl)C(F)(F)F)C2(C)C)cccc1-c1ccccc1 ; Cc1c(COC(=O)[C@H]2[C@@H](/C=C(\Cl)C(F)(F)F)C2(C)C)cccc1-c1ccccc1 ; CCCCN(CCCC)SN(C)C(=O)Oc1cccc2c1OC(C)(C)C2 ; CC1(C)[C@H](C(=O)OC(C#N)c2cccc(Oc3ccccc3)c2)[C@@H]1/C=C(\Cl)C(F)(F)F ; CC1(C)[C@H](/C=C(\Cl)C(F)(F)F)[C@@H]1C(=O)OC(C#N)c1cccc(Oc2ccccc2)c1]

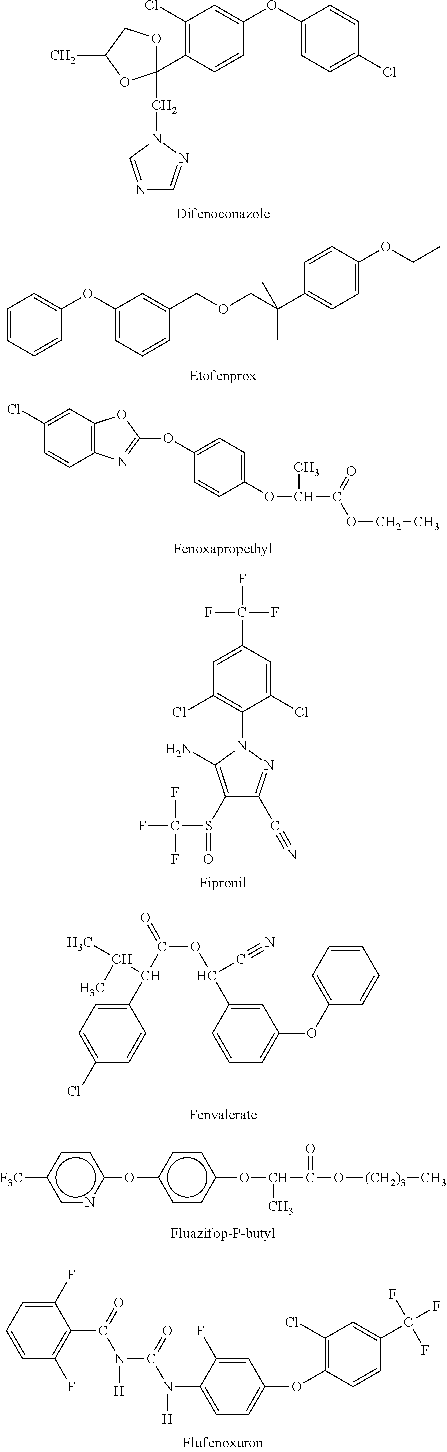

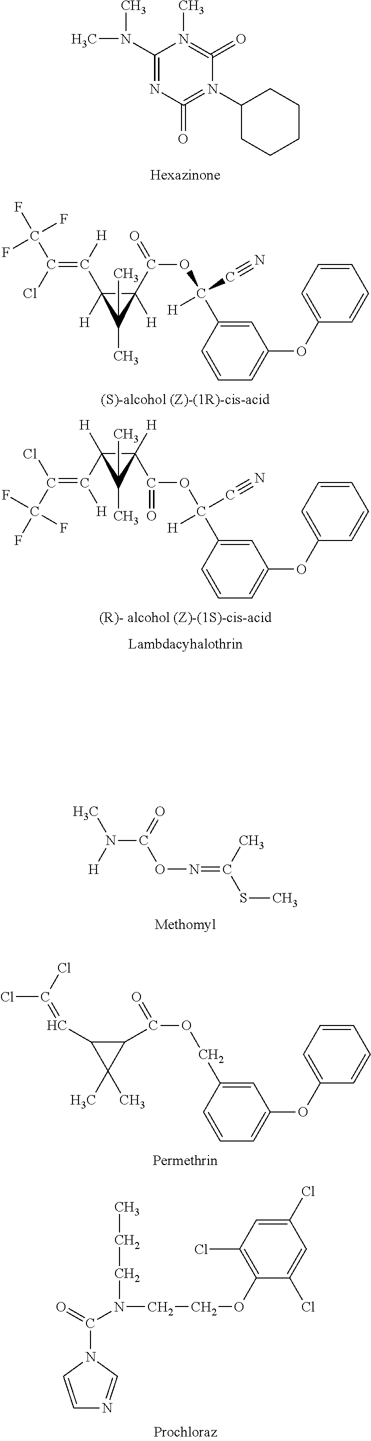

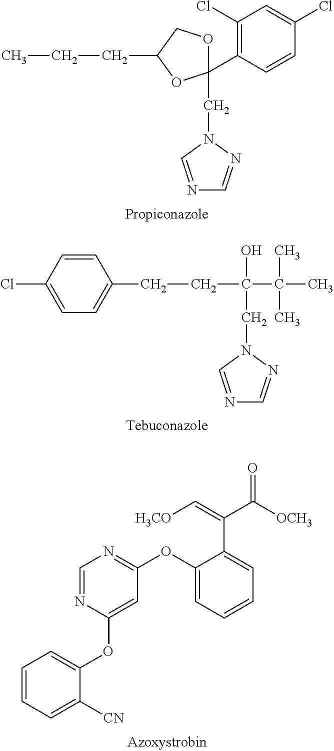 [SMILES: CCCC1COC(Cn2cncn2)(c2ccc(Cl)cc2Cl)O1 ; CC(C)(C)C(O)(CCc1ccc(Cl)cc1)Cn1cncn1 ; CO/C=C(/C(=O)OC)c1ccccc1Oc1cc(Oc2ccccc2C#N)ncn1]

These products and names are known to a person skilled in the art. It is possible to combine several plant-protection active products.

According to one embodiment of the invention, the plant-protection product is chosen from the following compounds: alachlor, chlorpyrifos, alpha-cypermethrin, phenmedipham, propanil, pendimethalin, tebuconazole, triadimenol, trifluralin, difenoconazole, dimethoate, imidacloprid, oxyfluorfen, propoxur and azoxystrobin.

According to a specific embodiment, the plant-protection product is chosen from imidacloprid, tebuconazole and trifluralin.

Surface-Active Agent (d)

The plant-protection formulation may comprise a surface-active agent, typically and preferably an emulsifier. The emulsifying agents are agents intended to facilitate the emulsification or the dispersion, after bringing the formulation into contact with water, and/or to stabilize (over time and/or with regard to the temperature) the emulsion or the dispersion, for example by preventing sedimentation and/or phase separation.

The surfactant may be an anionic surfactant, in the salified or acid form, a nonionic surfactant, preferably a polyalkoxylated surfactant, a cationic surfactant or an amphoteric surfactant (term also including zwitterionic surfactants). A mixture or a combination of these surfactants may be involved.

Mention may be made, as examples of anionic surfactants, without the intention to be limited thereto, of:
Alkylsulfonic acids or arylsulfonic acids, optionally substituted by one or more hydrocarbon groups, the acid functional group of which is partially or completely salified, such as C₈—O₅₀, more particularly C₈-C₃₀ and preferably C₁₀-C₂₂ alkylsulfonic acids, benzenesulfonic acids or naphthalenesulfonic acids substituted by one to three C₁-C₃₀, preferably C₄-C₁₆, alkyl groups and/or C₂-C₃₀, preferably C₄-C₁₆, alkenyl groups.
Mono- or diesters of alkyl sulfosuccinic acids, the linear or branched alkyl part of which is optionally substituted by one or more hydroxyl and/or linear or branched C₂-C₄ alkoxyl (preferably ethoxyl, propoxyl or ethopropoxyl) groups.
Phosphate esters more particularly chosen from those comprising at least one saturated, unsaturated or aromatic and linear or branched hydrocarbon group comprising from 8 to 40, preferably from 10 to 30, carbon atoms, optionally substituted by at least one alkoxyl (ethoxyl, propoxyl or ethopropoxyl) group. In addition, they comprise at least one mono- or diesterified phosphate ester group, so that it is possible to have one or two free or partially or completely salified acid groups. The preferred phosphate esters are of the type of the mono- and diesters of phosphoric acid and of alkoxylated (ethoxylated and/or propoxylated) mono-, di- or tristyrylphenol or of alkoxylated (ethoxylated and/or propoxylated) mono-, di- or trialkylphenol, optionally substituted by one to four alkyl groups; of phosphoric acid and of an alkoxylated (ethoxylated or ethopropoxylated) C₈-C₃₀, preferably C₁₀-C₂₂, alcohol; or of phosphoric acid and of a nonalkoxylated C₈-C₂₂, preferably C₁₀-C₂₂, alcohol.
Sulfate esters obtained from saturated or aromatic alcohols optionally substituted by one or more alkoxyl (ethoxyl, propoxyl or ethopropoxyl) groups and for which the sulfate functional groups exist in the free or partially or completely neutralized acid form. Mention may be made, by way of example, of the sulfate esters more particularly obtained from saturated or unsaturated C₈-C₂₀ alcohols which can comprise from 1 to 8 alkoxyl (ethoxyl, propoxyl or ethopropoxyl) units; the sulfate esters obtained from polyalkoxylated phenol substituted by 1 to 3 saturated or unsaturated C₂-C₃₀ hydrocarbon groups and in which the number of alkoxyl units is between 2 and 40; or the sulfate esters obtained from polyalkoxylated mono-, di- or tristyrylphenol in which the number of alkoxyl units varies from 2 to 40.

The anionic surfactants may be in the acid form (they are potentially anionic) or in a partially or completely salified form, with a counterion. The counterion may be an alkali metal, such as sodium or potassium, an alkaline earth metal, such as calcium, or also an ammonium ion of formula N(R)₄⁺ in which R, which are identical or different, represent a hydrogen atom or a C₁-C₄ alkyl radical optionally substituted by an oxygen atom.

Mention may be made, as examples of nonionic surfactants, without the intention to be limited thereto, of:
Polyalkoxylated (ethoxylated, propoxylated or ethopropoxylated) phenols substituted by at least one C₄-C₂₀, preferably C₄-C₁₂, alkyl radical or substituted by at least one alkylaryl radical, the alkyl part of which is a C₁-C₆ alkyl part. More particularly, the total number of alkoxyl units is between 2 and 100. Mention may be made, by way of example, of polyalkoxylated mono-, di- or tri(phenylethyl)phenols or polyalkoxylated nonylphenols. Mention may be made, among ethoxylated and/or propoxylated, sulfated and/or phosphated, di- or tristyrylphenols, of the ethoxylated di(1-phenylethyl)phenol comprising 10 oxyethylene units, the ethoxylated di(1-phenylethyl)phenol comprising 7 oxyethylene units, the ethoxylated and sulfated di(1-phenylethyl)phenol comprising 7 oxyethylene units, the ethoxylated tri(1-phenylethyl)phenol comprising 8 oxyethylene units, the ethoxylated tri(1-phenylethyl)phenol comprising 16 oxyethylene units, the ethoxylated and sulfated tri(1-phenylethyl)phenol comprising 16 oxyethylene units, the ethoxylated tri(1-phenylethyl)phenol comprising 20 oxyethylene units or the ethoxylated and phosphated tri(1-phenylethyl)phenol comprising 16 oxyethylene units.
Polyalkoxylated (ethoxylated, propoxylated or ethopropoxylated) C₆-C₂₂ fatty alcohols or acids. The number of the alkoxyl units is between 1 and 60. The term “ethoxylated fatty acid” includes both the products obtained by ethoxylation of a fatty acid with ethylene oxide and those obtained by esterification of a fatty acid with a polyethylene glycol.
Polyalkoxylated (ethoxylated, propoxylated or ethopropoxylated) triglycerides of vegetable or animal origin. The triglycerides resulting from lard, tallow, peanut oil, butter oil, cottonseed oil, linseed oil, olive oil, palm oil, grape seed oil, fish oil, soybean oil, castor oil, rapeseed oil, copra oil or coconut oil and comprising a total number of alkoxyl units of between 1 and 60 are thus suitable. The term “ethoxylated triglyceride” is targeted both at the products obtained by ethoxylation of a triglyceride with ethylene oxide and at those obtained by transesterification of a triglyceride with a polyethylene glycol.
Optionally polyalkoxylated (ethoxylated, propoxylated or ethopropoxylated) sorbitan esters, more particularly cyclized sorbitol esters of C₁₀ to C₂₀ fatty acids, such as lauric acid, stearic acid or oleic acid, comprising a total number of alkoxyl units of between 2 and 50.

Emulsifiers of use are in particular the following products, all sold by Rhodia:
Soprophor TSP/724: surfactant based on ethopropoxylated tristyrylphenol
Soprophor 796/O: surfactant based on ethopropoxylated tristyrylphenol
Soprophor CY 8: surfactant based on ethoxylated tristyrylphenol
Soprophor BSU: surfactant based on ethoxylated tristyrylphenol
Alkamuls RC: surfactant based on ethoxylated castor oil
Alkamuls OR/36: surfactant based on ethoxylated castor oil
Alkamuls T/20: surfactant based on an ethoxylated sorbitan ester.

The formulation advantageously comprises at least 2%, preferably at least 5%, preferably at least 8%, by weight of dry matter, of at least one surfactant (d).

It is mentioned that the solvent may be combined with an aromatic and/or nonaromatic surfactant.

Other Details with Regard to the Plant-Protection Formulation

The concentrated plant-protection formulation does not comprise large amounts of water. Typically, the water content is less than 50% by weight, advantageously less than 25% by weight. It will generally be less than 10% by weight.

The formulation is preferably a liquid formulation, for example in the form of an emulsifiable concentrate (EC), a concentrated emulsion (EW), a soluble concentrate (SL), a suspoemulsion (SE) or a microemulsion (ME). In this case, it preferably comprises less than 500 g/1 of water, more preferably less than 250 g/l. It will generally be less than 100 g/l.

The formulations can advantageously comprise:

a) from 0.01 to 60%, preferably from 10 to 50%, of the plant-protection product, by weight of active material,

b) from 10 to 92%, preferably from 20 to 80%, of the solvent, by weight,

c) from 1 to 88%, preferably from 2 to 78%, by weight of at least one cosolvent or another solvent,

d) from 4 to 60%, preferably from 5 to 50%, preferably from 8 to 25%, by weight of dry matter, of an emulsifier, preferably of a surfactant,

e) from 0 to 30%, preferably from 0 to 20%, by weight of water.

The production of solid formulations, for example of formulations in which a liquid comprising the plant-protection product dissolved in the solvent is supported by a mineral and/or dispersed in a solid matrix, is not ruled out.

The formulation may, of course, comprise ingredients (or “additives”) other than the plant-protection active product, the solvent(s), the optional emulsifying agent(s) and the optional water. It may in particular comprise viscosity-modifying agents, antifoaming agents, in particular silicone antifoaming agents, sticking agents, anti-leaching agents, inert fillers, in particular inorganic fillers, antifreeze agents, stabilizers, colorants, emetic agents or stickers (adhesion promoters).

In particular, the formulations may comprise cosolvents or other solvents c). The formulations comprise such other solvents in particular when the compound of formula (I) according to the invention is used as cosolvent.

The other solvents or cosolvents c) are preferably chosen from the following group:
saturated or unsaturated linear or branched aliphatic hydrocarbons optionally comprising a halogen, phosphorus, sulfur and/or nitrogen atom and/or a functional group,
saturated, unsaturated or aromatic carbocyclic or heterocyclic hydrocarbons optionally comprising a halogen, phosphorus, sulfur and/or nitrogen atom and/or a functional group.

More advantageously still, they are chosen from the following group:
alkanes, cycloalkanes and aromatic derivatives, for example linear- or branched-chain paraffins, such as white oil or decalin, mono-, di- or trialkylbenzenes or -naphthalenes, or compounds sold under the name Solvesso 100, 150 and 200 standard and ND grades;
aliphatic, cycloaliphatic or aromatic mono-, di- or triesters, for example alkyl alkanoates, such as methyl oleate; benzyl alkanoates; alkyl benzoates; γ-butyrolactone; caprolactone; esters of glycerol and citric acid; alkyl salicylates; phthalates; dibenzoates; acetoacetates; glycol ether acetates or dipropylene glycol diacetate;
mono-, di- or trialkyl phosphates, such as, for example, triethyl phosphate, tributyl phosphate or tri(2-ethylhexyl)phosphate;
aliphatic, cycloaliphatic, or aromatic ketones, such as, for example, dialkyl ketones; benzyl ketones; fenchone; acetophenone; cyclohexanone or alkylcyclohexanones;
aliphatic, cycloaliphatic or aromatic alcohols, such as, for example, glycols; 2-ethylhexanol; cyclohexanol; benzyl alcohols or tetrahydrofurfuryl alcohol;
aliphatic, cycloaliphatic or aromatic ethers, such as, for example, ethers of glycols, in particular ethylene glycol, propylene glycol and their polymers; diphenyl ether; dipropylene glycol; the monomethyl or monobutyl ether; tripropylene glycol monobutyl ether; alkoxyalkanols or dimethyl isosorbide;
fatty acids, such as, for example, linoleic acid, linolenic acid or oleic acid;
carbonates, such as, for example, propylene carbonate or butylene carbonate; lactates; fumarates; succinates; adipates or maleates;
amides, such as, for example, alkyldimethylamides or dimethyldecanamide;
alkylureas;
amines, such as, for example, alkanolamines, morpholine or N-alkylpyrrolidones;
tetramethylene sulfone;
dimethyl sulfoxide;
haloalkanes or halogenated aromatic solvents, such as, for example, chloroalkanes or chlorobenzene.

The other solvents particularly preferred are alkylbenzenes and -naphthalenes, the commercial compounds sold under the name Solvesso 100, 150, 200 standard and ND grades, alkanolamides and their alkyl ethers, fatty acids and their alkyl esters, such as, for example, methyl oleate, alkyldimethylamides, N-alkylpyrrolidones, trialkyl phosphates, (linear or branched) aliphatic alcohols and their esters, dibasic esters, (linear or branched) paraffins, such as white oil, glycols and glycol ethers, or acetophenone.

Crystallization inhibitors may also be present in the formulations. They may be the solvents mentioned above. They may also be nonpolyalkoxylated fatty acids or fatty alcohols (mention is made, for example, of the product Alkamuls® OL700 sold by Rhodia), alkanolamides, polymers and the like.

Conventional processes for the preparation of plant-protection formulations or mixtures of solvents may be employed. It is possible to carry out simple mixing of the constituents.

The concentrated plant-protection formulation is generally intended to be spread over a cultivated field or a field to be cultivated, for example of soya, generally after diluting in water, in order to obtain a dilute composition. Diluting is generally carried out by the farmer, directly in a tank (tank-mix), for example in the tank of a device intended to spread the composition. The addition by the farmer of other plant-protection products, for example fungicides, herbicides, pesticides or insecticides, fertilizers, adjuvants, and the like, is not ruled out. Thus, the formulation may be used to prepare a dilute composition in water of the plant-protection active product by mixing at least one part by weight of concentrated formulation with at least 10 parts of water, preferably less than 10 000 parts of water. The degrees of dilution and the amounts applied to the field generally depend on the plant-protection product and on the dose desirable for treating the field (this may be determined by the farmer).

The examples which follow illustrate the invention without, however, limiting it.

### EXAMPLES

### Example 1

### Preparation of the Furfurylideneketone Derivatives (1), (2), (3) and (4)

The compounds (1), (2), (3) and (4) were prepared according to the general protocol described above.

Three equivalents of ketone were mixed with 0.1 equivalent of sodium hydroxide in a round-bottomed flask. One equivalent of furfural is added via a pressure-equalizing dropping funnel.

The mixture is left stirring at ambient temperature (acetone, butanone) or it is heated at 60° C. (3-methyl-2-butanone, MIBK) for two hours and is then quenched with 37% hydrochloric acid to pH=4.

The reaction mixture is separated by settling, the organic phase is washed with distilled water and the aqueous phase is extracted with ethyl acetate. The organic phases are combined and concentrated to dryness.

The crude reaction product is distilled under reduced pressure.

### Crude Yields (NMR, Nonisolated Product)

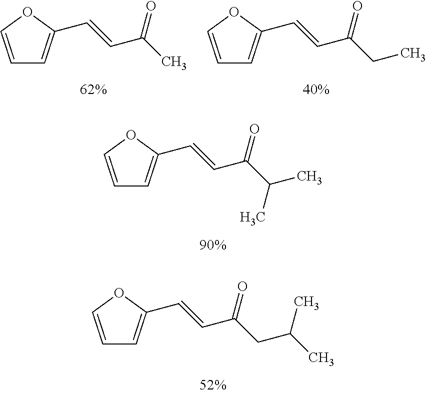

### Example 2

### Preparation of the Alkyl Furoate Derivatives (6) and (7)

The compounds (6) and (7) were prepared according to the general protocol described above.

One equivalent of furfural, 10 equivalents of alcohol and 0.1 equivalent of potassium iodide are mixed in a round-bottomed flask.

Three equivalents of t-butyl hydroperoxide (TBHP) are added via a pressure-equalizing dropping funnel.

The mixture is left at reflux of the alcohol for 20 hours.

The reaction medium is quenched by adding a saturated sodium sulfite solution to pH=7.

The reaction mixture is separated by settling and the organic phase is washed with distilled water. The organic phase is concentrated to dryness.

The crude reaction product is distilled under reduced pressure.

### Crude Yields (NMR, Nonisolated Product)

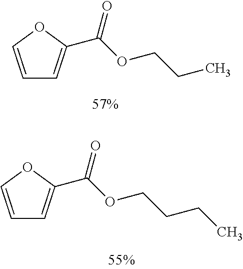

### Example 3

### Preparation of the Imine Derivatives (15) and (16)

The compounds (15) and (16) were prepared according to the general protocol described above.

One equivalent of furfural and one equivalent of MgSO₄ are mixed in toluene in a round-bottomed flask.

1.2 equivalents of amines in toluene are added via a dropping funnel.

The mixture is left stirring at ambient temperature for two hours.

The reaction mixture is subsequently filtered and concentrated to dryness.

### Crude Yields (NMR, Nonisolated Product)

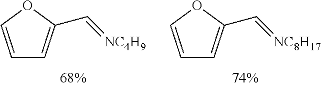

### Example 4

### Performances in Terms of Solubilization of Plant-Protection Active Agents

The numbers of the compounds correspond to the numbers of the compounds in the preceding table I.

The following table lists the solubilities obtained for the three plant-protection active principles tested: imidacloprid, tebuconazole and trifluralin.

Various samples with a concentration varying between 5 g/1 and 600 g/1 of plant-protection active principle in the test solvent were prepared. The tests were carried out on the milliliter scale (i.e., between 0.005 g/ml and 0.6 g/ml). The solutions are prepared in transparent glass flasks with a capacity of 5 ml. The plant-protection active principle is weighed out using a Qantos powder dispenser robot and then solvent is added using a Gilson solvent dispenser robot. Mixing is carried out using a vortex mixer at ambient temperature for 1 to 5 minutes. After 24 hours at ambient temperature, the solutions comprising different concentrations of plant-protection active principles in the flasks are observed visually (a). The flasks are placed for 24 hours in a chamber at a temperature controlled at 0° C. and are then observed again (b). The samples are subsequently seeded: a grain of plant-protection active principle is added to each mixture. The flasks are again placed at 0° C. and are observed after 24 hours (c).

For each observation (a, b or c), the solubility is determined as being within the range ( . . . - . . . ) defined by: maximum concentration of the samples prepared at which all the plant-protection active principle is dissolved—minimum concentration of the samples to be prepared to which grains of active principle are not dissolved.

| | | | Nonseeded | | |
|---|---|---|---|---|---|
| | | | solubility at | Nonseeded | Solubility at |
| | | | ambient | solubility at | 0° C. with |
| | | | temperature | 0° C. | seeding |
| | Compound | | (g/l) | (g/l) | (g/l) |
| Subfamily | number | Active principle | (a) | (b) | (c) |
| (i) | (1) | Tebuconazole | 250-260* | n.a* | n.a* |
| | | Trifluralin | 540-550* | n.a* | n.a* |
| | (2) | Imidacloprid | 20-40 | 20-40 | 20-40 |
| | | Tebuconazole | 180-200 | 180-200 | 120-140 |
| | | Trifluralin | >480 | 450-570 | 105-150 |
| | (3) | Imidacloprid | 8-16 | 8-16 | 8-16 |
| | | Tebuconazole | 160-180 | 160-180 | 100-120 |
| | | Trifluralin | >530 | >530 | 370-410 |
| (ii) | (6) | Tebuconazole | 220-240 | 220-240 | 140-180 |
| | | Trifluralin | >500 | >500 | 360-500 |
| | (7) | Tebuconazole | 180-220 | 180-220 | 100-140 |
| | | Trifluralin | >520 | 370-520 | 320-360 |

*As the compound (1) is solid at ambient temperature, the protocol is adjusted. The solvent is heated on a water bath at 30° C. before the test in order to render it liquid. The tests (b) and (c) are thus not carried out for this compound.

It emerges that all of the compounds tested can be used as solvents for plant-protection products.

### Example 5

### Performances in Terms of Solubilization of Resins

The following table lists the solubilities obtained for four resins tested: BADGE DER 331 epoxy resin sold by DOW CHEMICAL, Palatal A400-01 polyester resin sold by DSM, Novolac DEN 425 epoxy resin sold by DOW CHEMICAL and TGPA resin available from Sigma Aldrich.

A single solubility test was carried out per solvent/resin pair, at a working concentration of 100 g/l, at ambient temperature. The tests were carried out on the milliliter scale (i.e., 0.5 g/5 ml). The tests are carried out in transparent glass flasks. The resin (0.5 g) is weighed into the flask and then the required volume (5 ml) of test solvent is introduced into this same flask. Stirring is carried out using a vortex mixer for 1 to 5 minutes. The results for solubility of the resins in the solvents tested, shown in the table below, are obtained by visual observations.

| | Compound | | Solubility at ambient |
|---|---|---|---|
| Subfamily | number | Active principle | temperature (100 g/l) |
| (i) | (1) | BADGE DER 331 | Soluble* |
| | | Palatal A400-01 | Soluble* |
| | | Novolac DEN 425 | Soluble* |
| | (3) | BADGE DER 331 | Soluble |
| | | Palatal A400-01 | Soluble |
| | | Novolac DEN 425 | Soluble |
| | | TGPA | Soluble |
| (ii) | (6) | BADGE DER 331 | Partial |
| | | Palatal A400-01 | Soluble |
| | | Novolac DEN 425 | Soluble |
| | (8) | BADGE DER 331 | Soluble |
| | | Palatal A400-01 | Soluble |
| | | Novolac DEN 425 | Soluble |
| | | TGPA | Soluble |
| | (9) | BADGE DER 331 | Soluble |
| | | Palatal A400-01 | Soluble |
| | | Novolac DEN 425 | Soluble |
| | | TGPA | Soluble |
| | (10) | BADGE DER 331 | Soluble |
| | | Palatal A400-01 | Soluble |
| | | Novolac DEN 425 | Soluble |
| | | TGPA | Soluble |
| (iv) | (15) | BADGE DER 331 | Partial |
| | | Palatal A400-01 | Soluble |
| | | Novolac DEN 425 | Soluble |
| | | TGPA | Soluble |
| | (16) | BADGE DER 331 | Partial |
| | | Palatal A400-01 | Soluble |
| | | Novolac DEN 425 | Soluble |
| | | TGPA | Soluble |
| (v) | (17) | BADGE DER 331 | Soluble |
| | | Palatal A400-01 | Soluble |
| | | Novolac DEN 425 | Soluble |
| | | TGPA | Soluble |

*As the compound (1) is solid at ambient temperature, the protocol is adjusted. The solvent is heated on a water bath at 30° C. before the test in order to render it liquid.

It emerges that all of the compounds tested can be used as solvents for resins.

1. A method for dissolving a chemical compound, comprising dissolving the chemical compound in a compound of formula (I): 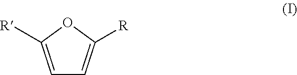
in which:
R represents:
(i) a —CH═CR′₁—COR₁ group, in which R₁ represents a hydrogen atom, an OH group, a (C₁-C₁₀)alkoxy group, a (C₁-C₁₀)alkyl group or a (C₁-C₁₀)alkenyl group and in which R′₁ represents a hydrogen atom, a (C₁-C₈)alkyl group or a (C₁-C₈)alkenyl group,
(ii) a 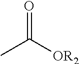
group, in which R₂ represents:
a (C₁-C₁₀)alkyl group or a (C₁-C₁₀)alkenyl group, wherein R and R₂ may each optionally be interrupted by an oxygen atom and may each optionally be substituted by one or two group(s) chosen from a hydroxyl group, a (C₁-C₄)alkoxy group and a phenyl group,
a (C₃-C₆)cycloalkyl group, and
a phenyl or furfuryl group,
(iii) a 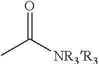
group, in which R₃ represents a (C₁-C₁₀)alkyl group, it being possible for said group to be optionally substituted by one or two hydroxyl group(s), or represents a (C₃-C₆)cycloalkyl group and R₃′ represents a hydrogen atom or a (C₁-C₆)alkyl group which can be substituted by one or two hydroxyl group(s),
(iv) a 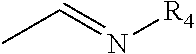
group, in which R₄ represents a (C₁-C₁₀)alkyl group or represents a (C₃-C₆)cycloalkyl group, or
(v) a —CHO group, and
R′ represents a hydrogen atom or a (C₁-C₄)alkyl group, in particular a methyl group.

2. The method as claimed in claim 1, wherein:
R represents:
(i) a —CH═CH—COR₁ group, in which R₁ represents a (C₁-C₆)alkoxy group or a (C₁-C₆)alkyl group,
(ii) a 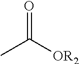
group, in which R₂ represents a (C₁-C₆)alkyl group, which can be substituted by a phenyl group or a hydroxyl group,
(iii) a 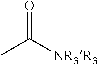
group, in which R₃ represents a (C₁-C₈)alkyl group and R₃′ represents a hydrogen atom,
(iv) a 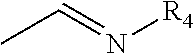
group, in which R₄ represents a (C₁-C₈)alkyl group, or
(v) a —CHO group, and
R′ represents a hydrogen atom or a methyl group.

3. The method as claimed in claim 1, wherein the compound of formula (I) is chosen from the following compounds:

| Compound | | |
|---|---|---|
| number | Subfamily | Formula |
| (1) | (i) | 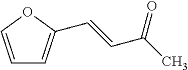 |
| (2) | (i) | 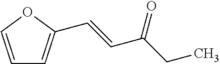 |
| (3) | (i) | 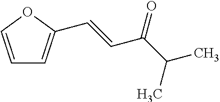 |
| (4) | (i) | 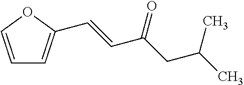 |
| (5) | (i) | 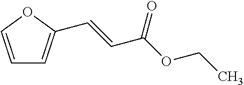 |
| (6) | (ii) | 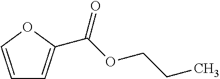 |
| (7) | (ii) | 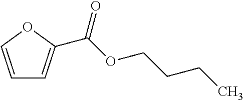 |
| (8) | (ii) | 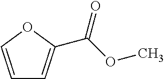 |
| (9) | (ii) | 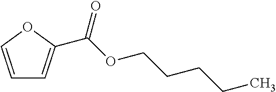 |
| (10) | (ii) | 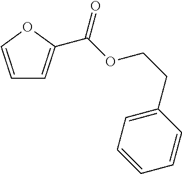 [SMILES: O=C(OCCc1ccccc1)c1ccco1] |
| (11) | (ii) | 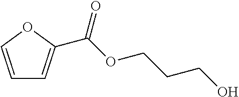 [SMILES: O=C(OCCCO)c1ccco1] |
| (12) | (ii) | 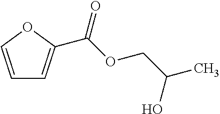 |
| (13) | (iii) | 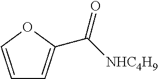 |
| (14) | (iii) | 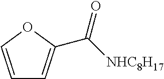 |
| (15) | (iv) | 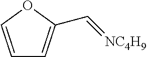 |
| (16) | (iv) | 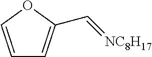 |
| (17) | (v) | 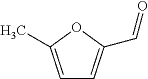 |

4. The method as claimed in claim 1, wherein:
R represents:
(i) a —CH═CH—COR₁ group, in which R₁ represents a (C₁-C₆)alkyl group or a (C₁-C₄)alkoxy group,
(ii) a 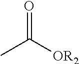
group, in which R₂ represents a (C₁-C₆)alkyl group which can be substituted by a phenyl group or a hydroxyl group, or
(v) a —CHO group, and
R′ represents a hydrogen atom or a methyl group.

5. The method of claim 1, wherein the chemical compound is a plant-protection product or resin.

6. The method of claim 1, wherein the chemical compound is an epoxy resin is chosen from glycidyl ether epoxy, glycidyl ester epoxy, glycidyl amine epoxy, aliphatic nonglycidyl epoxy and cycloaliphatic glycidyl epoxy resins and in particular from bisphenol A diglycidyl ether, triglycidyl p-aminophenol ether, the glycidyl ethers of novolac phenolic resins or also from bisphenol F diglycidyl ether, tetraglycidyl methylenedianiline, pentaerythritol tetraglycidyl ether, tetrabromobisphenol A diglycidyl ether, hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, terephthalic acid diglycidyl ester, poly(glycidyl acrylate), poly(glycidyl methacrylate) and their mixtures.

7. The method of claim 1, wherein the chemical compound is an polyester resin is obtained by a condensation polymerization reaction starting from diols, such as propylene glycol or bisphenol A and unsaturated acids or their anhydrides, such as fumaric acid or maleic anhydride, together with saturated acids or their anhydrides, for example isophthalic acid, orthophthalic acid or phthalic anhydride.

8. (canceled)

9. The method of claim 1, wherein the chemical compound is plant protection product chosen from the following compounds: alachlor, chlorpyrifos, alpha-cypermethrin, phenmedipham, propanil, pendimethalin, tebuconazole, triadimenol, trifluralin, difenoconazole, dimethoate, imidacloprid, oxyfluorfen, propoxur, and azoxystrobin.

10. A composition, comprising a chemical compound selected from plant protection compounds and resins, and at least one compound of formula (I): 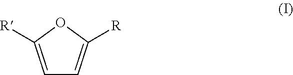
wherein:
R represents:
(i) a —CH═CR′₁—COR₁ group, in which R₁ represents a hydrogen atom, an OH group, a (C₁-C₁₀)alkoxy group, a (C₁-C₁₀)alkyl group or a (C₁-C₁₀)alkenyl group and in which R′₁ represents a hydrogen atom, a (C₁-C₈)alkyl group or a (C₁-C₈)alkenyl group,
(ii) a 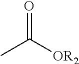
group, in which R₂ represents:
a (C₁-C₁₀)alkyl group or a (C₁-C₁₀)alkenyl group, wherein R and R₂ may each optionally be interrupted by an oxygen atom and may each optionally be substituted by one or two group(s) chosen from a hydroxyl group, a (C₁-C₄)alkoxy group and a phenyl group,
a (C₃-C₆)cycloalkyl group, and
a phenyl or furfuryl group,
(iii) a 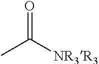
group, in which R₃ represents a (C₁-C₁₀)alkyl group, it being possible for said group to be optionally substituted by one or two hydroxyl group(s), or represents a (C₃-C₆)cycloalkyl group and R₃′ represents a hydrogen atom or a (C₁-C₆)alkyl group which can be substituted by one or two hydroxyl group(s),
(iv) a 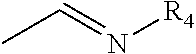
group, in which R₄ represents a (C₁-C₁₀)alkyl group or represents a (C₃-C₆)cycloalkyl group, or
(v) a —CHO group, and
R′ represents a hydrogen atom or a (C₁-C₄)alkyl group, in particular a methyl group.

11. The composition of claim 10, wherein:
R represents:
(i) a —CH═CH—COR₁ group, in which R₁ represents a (C₁-C₆)alkoxy group or a (C₁-C₆)alkyl group,
(ii) a 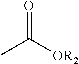
group, in which R₂ represents a (C₁-C₆)alkyl group, which can be substituted by a phenyl group or a hydroxyl group,
(iii) a 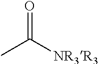
group, in which R₃ represents a (C₁-C₈)alkyl group and R₃′ represents a hydrogen atom,
(iv) a 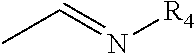
group, in which R₄ represents a (C₁-C₈)alkyl group, or
(v) a —CHO group, and
R′ represents a hydrogen atom or a methyl group.

12. The composition of claim 10 wherein R represents:
(i) a —CH═CH—COR₁ group, in which R₁ represents a (C₁-C₆)alkyl group or a (Cᵣ C₄)alkoxy group,
(ii) a 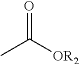
group, in which R₂ represents a (C₁-C₆)alkyl group which can be substituted by a phenyl group or a hydroxyl group, or
(v) a —CHO group, and
R′ represents a hydrogen atom or a methyl group.

13. The composition of claim 10, wherein the compound of formula (I) is chosen from the following compounds:

| Compound | | |
|---|---|---|
| number | Subfamily | Formula |
| (1) | (i) | 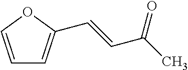 |
| (2) | (i) | 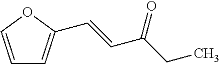 |
| (3) | (i) | 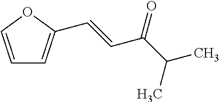 |
| (4) | (i) | 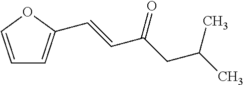 |
| (5) | (i) | 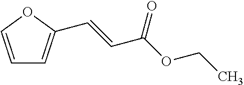 |
| (6) | (ii) | 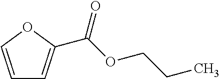 |
| (7) | (ii) | 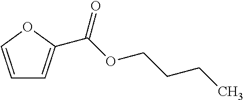 |
| (8) | (ii) | 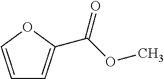 |
| (9) | (ii) | 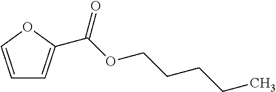 |
| (10) | (ii) | 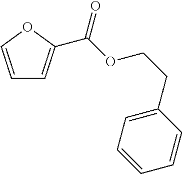 [SMILES: O=C(OCCc1ccccc1)c1ccco1] |
| (11) | (ii) | 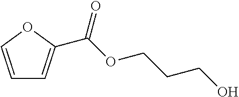 [SMILES: O=C(OCCCO)c1ccco1] |
| (12) | (ii) | 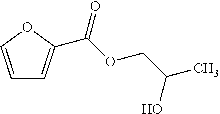 |
| (13) | (iii) | 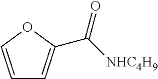 |
| (14) | (iii) | 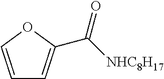 |
| (15) | (iv) | 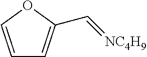 |
| (16) | (iv) | 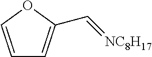 |
| (17) | (v) | 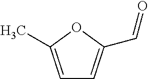 |

14. The composition of claim 10, wherein the chemical compound is a plant-protection product or a resin.

15. The composition of claim 10, wherein the chemical compound is an epoxy resin, a polyurethane resin, or a polyester resin.

16. The composition of claim 10, wherein the chemical compound is an epoxy resin chosen from glycidyl ether epoxy, glycidyl ester epoxy, glycidyl amine epoxy, aliphatic nonglycidyl epoxy and cycloaliphatic glycidyl epoxy resins and in particular from bisphenol A diglycidyl ether, triglycidyl p-aminophenol ether, the glycidyl ethers of novolac phenolic resins or also from bisphenol F diglycidyl ether, tetraglycidyl methylenedianiline, pentaerythritol tetraglycidyl ether, tetrabromobisphenol A diglycidyl ether, hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentyl glycol diglycidyl ether, bisphenol A polyethylene glycol diglycidyl ether, bisphenol A polypropylene glycol diglycidyl ether, terephthalic acid diglycidyl ester, poly(glycidyl acrylate), poly(glycidyl methacrylate) and their mixtures.

17. The composition of claim 10, wherein the chemical compound is a polyester resin is obtained by a condensation polymerization reaction starting from diols, such as propylene glycol or bisphenol A and unsaturated acids or their anhydrides, such as fumaric acid or maleic anhydride, together with saturated acids or their anhydrides, for example isophthalic acid, orthophthalic acid or phthalic anhydride.

18. The composition of claim 10, wherein the chemical compound is a plant protection product chosen from the following compounds: alachlor, chlorpyrifos, alpha-cypermethrin, phenmedipham, propanil, pendimethalin, tebuconazole, triadimenol, trifluralin, difenoconazole, dimethoate, imidacloprid, oxyfluorfen, propoxur and azoxystrobin.

19. The composition of claim 10, wherein the chemical compound is a plant protection compound selected from imidacloprid, tebuconazole, and trifluralin.

20. The method of claim 1, wherein the chemical compound comprises oil grease, wax, resin, or paint to be removed.

21. The method of claim 1, wherein compound of formula (I) is an agent for coalescing, inhibiting crystallization of, plasticizing, or enhancing biological activity a formulation comprising the chemical compound and the compound of formula (I).
